(19) United States
(12) Patent Application Publication
(10) Pub. No.: US 2020/0216252 A1
(43) Pub. Date: Jul. 9, 2020

(54) SUSPENDABLE DUNNAGE

(71) Applicant: Signode Industrial Group LLC, Glenview, IL (US)

(72) Inventor: Humberto Laguna, Chowchilla, CA (US)

(21) Appl. No.: 16/242,342

(22) Filed: Jan. 8, 2019

(51) Int. Cl. B65D 81/127; F16M 13/02; B65D 81/107; B60P 7/16

(52) U.S. Cl. CPC B65D 81/127; F16M 13/022; B65D 19/38; B60P 7/16; B65D 81/107

(57) ABSTRACT

Various embodiments of the present disclosure provide dunnage including a void filler and an attachment member usable to suspend the void filler in midair adjacent a palletized load of goods.

### FIELD

The present disclosure relates to dunnage used to secure cargo during transit, and more particularly to dunnage suspendable in midair adjacent the cargo.

### BACKGROUND

Dunnage is used to stabilize cargo during transportation of cargo containers. Generally, after some or all of the cargo is loaded into a cargo container, dunnage is positioned in the voids between the cargo to fill the voids and limit movement of the cargo during transit.

### SUMMARY

Various embodiments of the present disclosure provide dunnage including a void filler and an attachment member usable to suspend the void filler in midair adjacent a palletized load of goods.

### BRIEF DESCRIPTION OF THE FIGURES

FIGS. 1A and 1B are front and back perspective views, respectively, of one example embodiment of the suspendable dunnage of the present disclosure. Parts of the first and second panels of the void filler of the suspendable dunnage are cut away to illustrate the core between the first and second panels.

FIGS. 2A and 2B are front and back elevational views, respectively, of the suspendable dunnage of FIGS. 1A and 1B.

FIGS. 2C and 2D are top and bottom plan views, respectively, of the suspendable dunnage of FIGS. 1A and 1B.

FIGS. 2E and 2F are right-side and left-side elevational views, respectively, of the suspendable dunnage of FIGS. 1A and 1B.

FIGS. 3A-3C show a method of using an attachment member of the suspendable dunnage of FIGS. 1A and 1B to suspend a void filler of the suspendable dunnage in midair adjacent a load of goods positioned on a pallet and wrapped in stretch film

FIG. 3D is a partial side elevational view of the suspendable dunnage of FIGS. 1A and 1B suspended in midair adjacent the load of goods of FIGS. 3A-3C.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, etc., are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

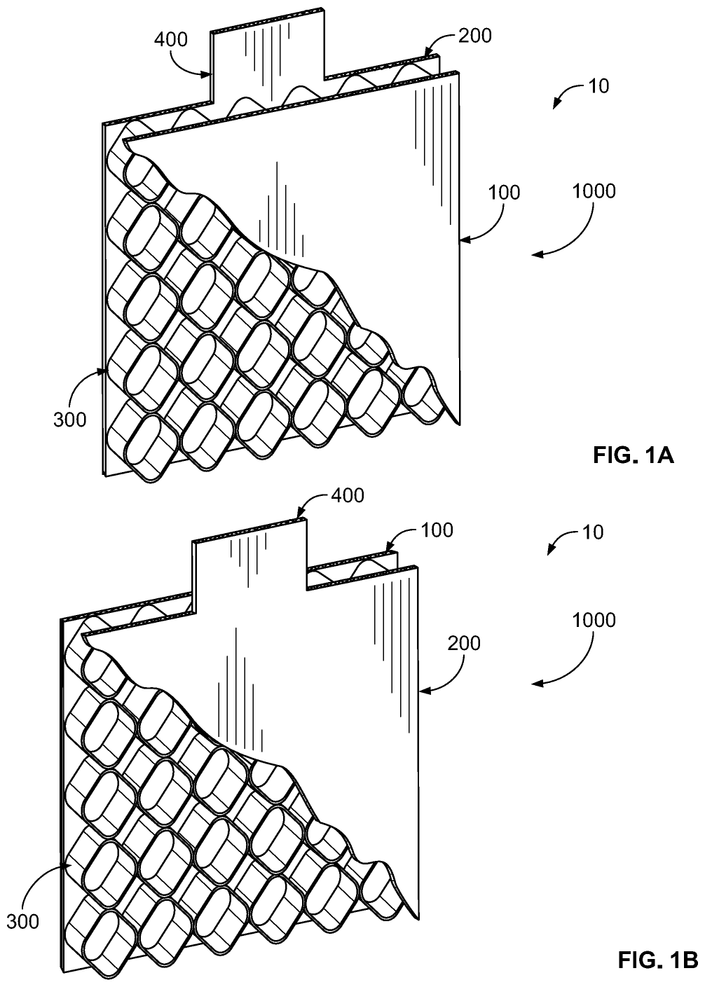

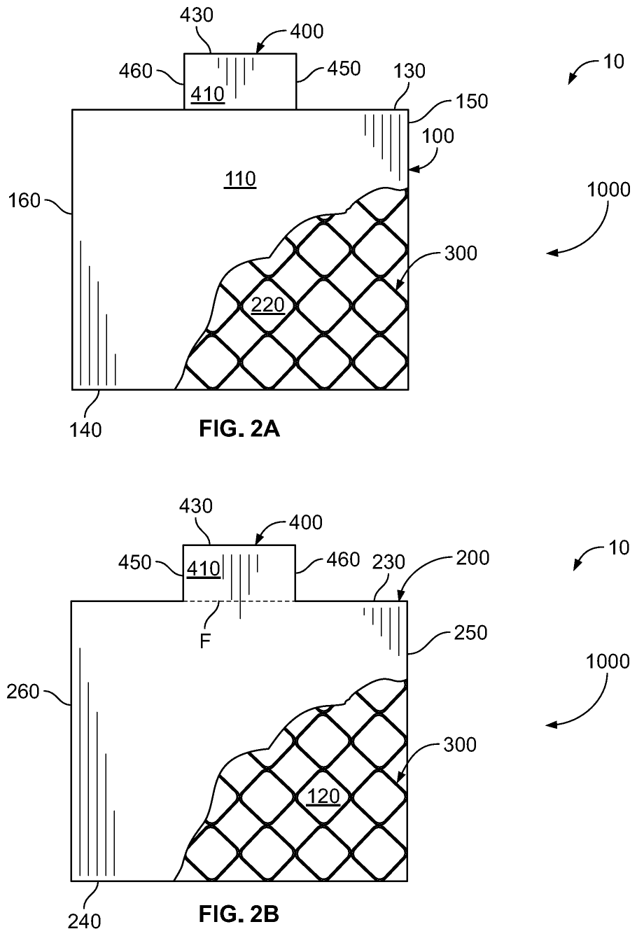

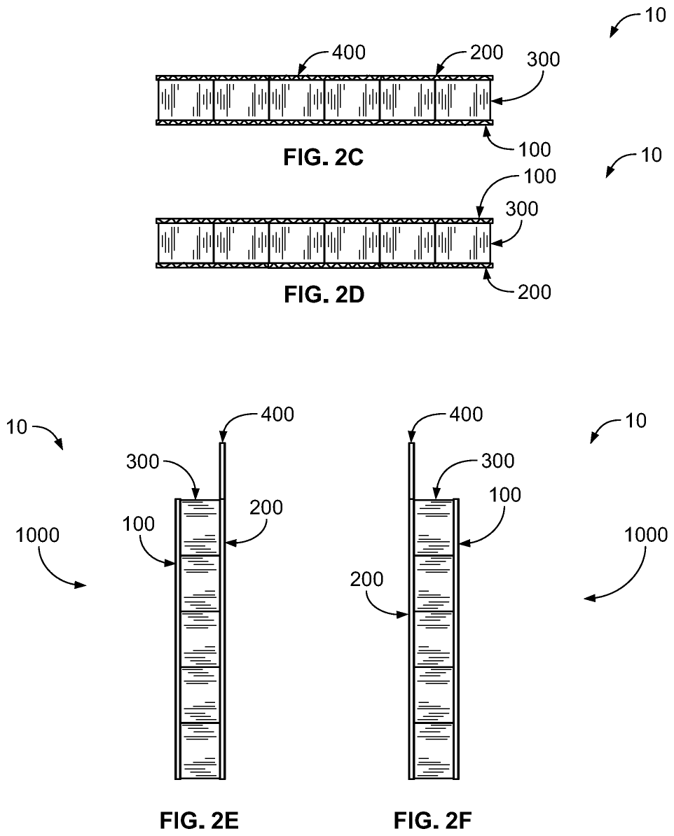

Various embodiments of the present disclosure provide dunnage including a void filler and an attachment member usable to suspend the void filler in midair adjacent a palletized load of goods. FIGS. 1A-2F show one embodiment of the suspendable dunnage 10 (sometimes referred to as the “dunnage” for brevity) of the present disclosure. The dunnage 10 includes a void filler 1000 and an attachment member 400.

The void filler 1000 includes a first panel 100, a second panel 200, and a core 300.

As best shown in FIGS. 2A and 2B, the first panel 100 includes a first face 110, a second face 120 opposite the first face 110, a top edge 130, a bottom edge 140 opposite the top edge 130, a first side edge 150, and a second side edge 160 opposite the first side edge 150. In this example embodiment, the first panel 100 is rectangular and formed from corrugated fiberboard, though the first panel may take any suitable shape and be formed from any suitable material in other embodiments.

As best shown in FIGS. 2A and 2B, the second panel 200 includes a first face 210, a second face 220 opposite the first face 210, a top edge 230, a bottom edge 240 opposite the top edge 230, a first side edge 250, and a second side edge 260 opposite the first side edge 250. In this example embodiment, the second panel 200 is rectangular and formed from corrugated fiberboard, though the second panel may take any suitable shape and be formed from any suitable material in other embodiments.

As best shown in FIGS. 2A and 2B, the core 300 is connected to (such as via adhesive) and extends between the second faces 120 and 220 of the first and second panels 100 and 200, respectively. The core 300 is formed from multiple plies of corrugated paperboard attached to one another and expanded to form multiple adjacent cells arranged in an array between the first and second panels 100 and 200. This is merely one example of the core 300, and any suitable core may be employed (such as a solid foam core). In this example embodiment the core forms cells having a rectangular cross-section, though the cells may have any other suitably shaped cross-section (such as a hexagonal cross-section) in other embodiments.

The attachment member 400 includes a first face 410, a second face 420 opposite the first face 410, a top edge 430, a bottom edge opposite the top edge 430 that in this embodiment is identified by a fold line F (which in certain embodiments corresponds to a score in the second panel of the void filler), a first side edge 450, and a second side edge 460 opposite the first side edge 450. In this example embodiment, the attachment member 400 is rectangular and formed from corrugated fiberboard, though the attachment member may take any suitable shape and be formed from any suitable material in other embodiments. The fold line may be creased in certain embodiments to facilitate folding the attachment member 400 as described below.

The attachment member 400 is attached to the void filler 1000. More particularly, in this embodiment (as best shown in FIG. 2B), the attachment member 400 is integrally formed with the void filler 1000, and more specifically with the second panel 200 such that the attachment member 400 extends from the top edge 230 of the second panel 200. In this embodiment, the fold line F separates the attachment member 400 and the second panel 200 such that the attachment member 400 can be folded along the fold line F and rotated relative to the second panel 200, as explained below. In other embodiments, the attachment member is not integrally formed with the void filler, but instead attached to the second panel via an adhesive, staples, tape, or any other suitable manner In certain embodiments, the suspendable dunnage includes two attachment members, each of which is attached to a different one of the panels of the void filler. In these embodiments, the suspendable dunnage is reversible in that either attachment member can be used to suspend the void filler in place adjacent a load of goods (as described below).

In one example embodiment, the first and second panels of the core are 40 inches tall and 48 inches wide, and the attachment member (which is centered on the second panel in the side-to-side direction) is 8 inches tall and 16 inches wide, thought these components may be of any suitable size. The core is 3 inches thick in this embodiment, but may be any suitable thickness in other embodiments (such as 1-6 inches thick).

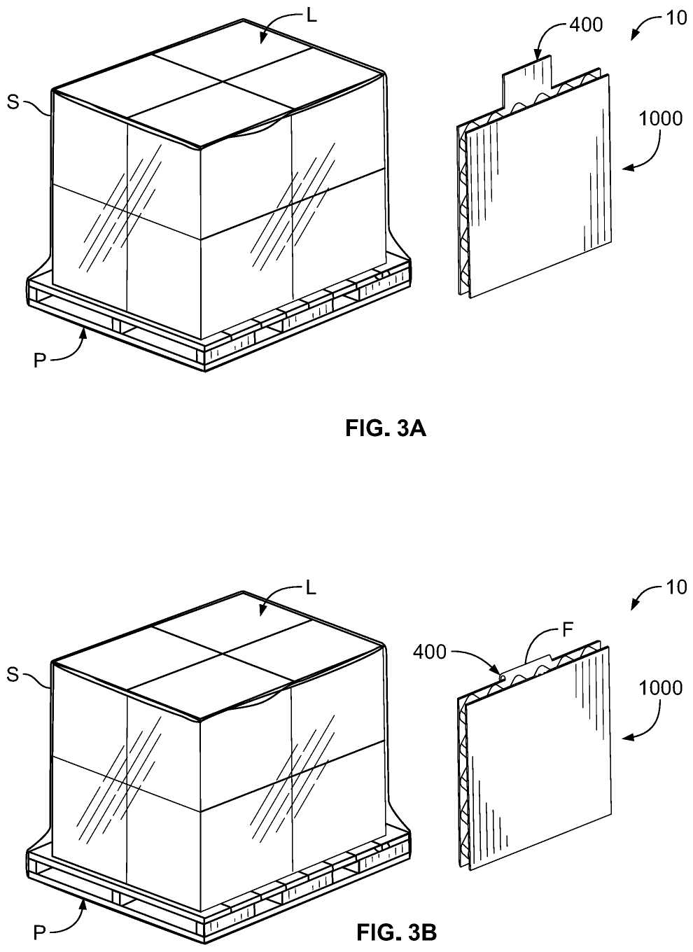

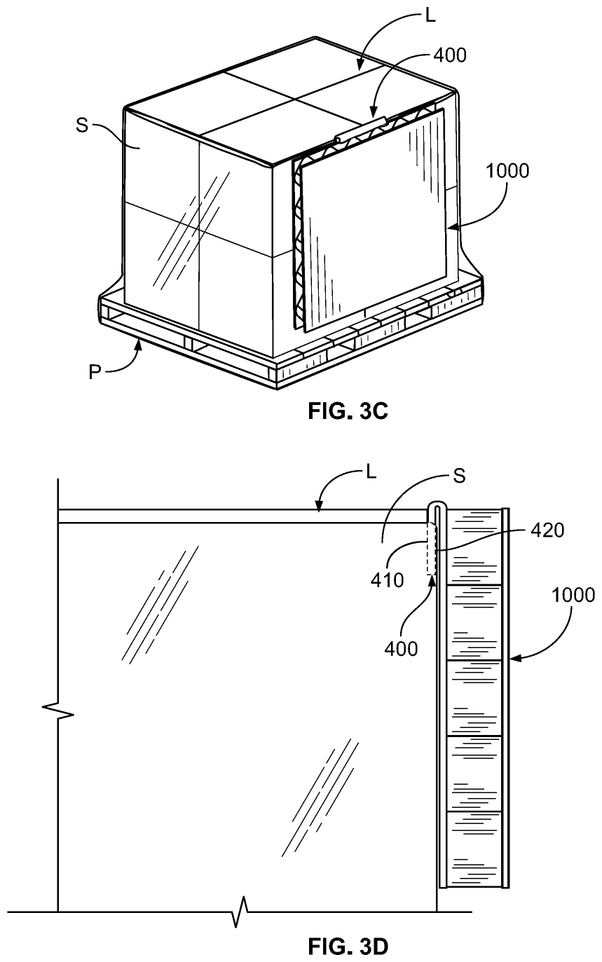

FIGS. 3A-3C show a method of using the attachment member 400 to suspend the void filler 1000 in place adjacent a load of goods L positioned on a pallet P and wrapped in stretch film S As shown in FIG. 3A, an installer first positions the dunnage 10 such that the first face 210 of the second panel 200 is adjacent the load L. As shown in FIG. 3B, the installer then folds the attachment member 400 about the fold line F downward relative to the second panel 200 of the void filler 1000 such that the second face 420 of the attachment member 400 faces the first face 210 of the second panel 200 of the void filler 1000, i.e., such that an angle defined between the attachment member 400 and the second panel 200 is less than 90 degrees. The installer then inserts the attachment member 400 from the top down between the stretch film S and the load of goods L (or between adjacent layers of the stretch film S) such that: (1) the fold line F is adjacent an upper edge of the stretch film S; (2) the first face 410 of the attachment member 400 abuts the load of goods L; and (3) the second face 420 of the attachment member 400 abuts the stretch film S, as shown in FIGS. 3C and 3D.

Once the attachment member 400 is inserted between the stretch film S and the load of goods L, the tension applied by the stretch film S is large enough to retain the attachment member 400and therefore the void filler 1000 attached thereto (and here integrally formed therewith)securely in place relative to the load of goods L. In this example embodiment, the attachment member 400 suspends the bottom edges 140 and 240 of the first and second panels 100 and 200 of the void filler 1000 above the bottom of the pallet P (and therefore above whatever support surface supports the pallet P). The materials that form the second panel 200 and the attachment member 400 are strong enough to support the void filler 1000 without it detaching from the attachment member 400. Put differently, in this example embodiment, the attachment member 400 is configured to suspend the void filler 1000 in midair adjacent the load of goods L.

The suspendable dunnage of the present disclosure and its method of installation improves upon known void fillers and methods of installing those known void fillers. To attach a known void filler to a wrapped load of goods, an installer must tape (or otherwise adhere) the known void filler to the stretch film wrapped around the load of goods. This is time-consuming and requires the purchase and use of extra material (e.g., tape). The suspendable dunnage of the present disclosure solves these problems via the inclusion of the attachment member, which enables the installer to quickly and easily position the void filler as desired adjacent a wrapped load of goods such that the void filler remains in place wherever that load of goods is transported. This process is quicker and easier than taping and has the added benefit of not requiring the purchase of additional materials (e.g., tape).

In other embodiments, clips (not shown) are used to secure the void filler to the stretch film to help retain the void filler suspended in midair adjacent the load of goods. In these embodiments, the installer installs the clips such that one leg abuts the inner surface of the stretch film and the other legs abuts the inner surface of the second panel of the void filler. The legs are biased toward one another (such as via a spring or the orientation of the legs) such that the clip pinches the stretch film and the second panel and retains the second panel in place. In some embodiments the void filler does not include an attachment member, and the clips are used to suspend the void filler in place adjacent the load.

In certain embodiments, part of the second panel is not attached to the core, and that unattached part of the second panel forms the attachment member.

1. Suspendable dunnage comprising:
a void filler comprising a first panel, a second panel spaced apart from the first panel, and a core between the first and second panels; and
an attachment member attached to the second panel such that the attachment member is foldable relative to the void filler.

2. The suspendable dunnage of claim 1, wherein the attachment member is integrally formed with the second panel.

3. The suspendable dunnage of claim 1, wherein the attachment member is attached to the second panel via at least one selected from the group consisting of:
adhesive, tape, and one or more staples.

4. The suspendable dunnage of claim 1, wherein the attachment member is foldable relative to the void filler about a fold line demarcated by a score.

5. The suspendable dunnage of claim 1, wherein the core defines multiple unfilled cells between the first and second panels.

6. The suspendable dunnage of claim 5, wherein the core is formed from multiple plies of material attached to one another.

7. The suspendable dunnage of claim 6, wherein the cells have a hexagonal cross-section.

8. The suspendable dunnage of claim 7, wherein the attachment member is integrally formed with the second panel.

9. A method of suspending dunnage adjacent a load of goods wrapped in film, the dunnage comprising a void filler comprising a first panel, a second panel spaced apart from the first panel, and a core between the first and second panels; and
an attachment member attached to the second panel such that the attachment member is foldable relative to the void filler, the method comprising:
folding the attachment member relative to the second panel; and
attaching the attachment member to the load such that the void filler is suspended above a surface supporting the load.

10. The method of claim 9, wherein folding the attachment member relative to the panel comprises folding the attachment member relative to the second panel such that an angle defined between the attachment member and the second panel is less than 90 degrees.

11. The method of claim 9, wherein attaching the attachment member to the load such that the void filler is suspended above a surface supporting the load comprises inserting the attachment member from the top down between the film and the load.

12. The method of claim 11, wherein after insertion one face of the attachment member contacts the film and an opposite face of the attachment member contacts the load.

13. The method of claim 9, wherein attaching the attachment member to the load such that the void filler is suspended above a surface supporting the load comprises inserting the attachment member from the top down between the two overlapping layers of the film.

14. The method of claim 13, wherein after insertion both faces of the attachment member contact the film.
